(19) United States
(12) Patent Application Publication
(10) Pub. No.: US 2020/0101485 A1
(43) Pub. Date: Apr. 2, 2020

(54) COATING APPARATUS FOR MOVING WEB

(71) Applicant: 3M INNOVATIVE PROPERTIES COMPANY, St. Paul, MN (US)

(72) Inventors: Chris J. Tanley, Stillwater, MN (US); Bruce E. Tait, Woodbury, MN (US); Scott A. Walker, White Bear Lake, MN (US); Mark C. Berens, Oakdale, MN (US)

(21) Appl. No.: 16/472,127

(22) PCT Filed: Dec. 21, 2017
(86) PCT No.: PCT/US2017/067989

§ 371 Date: Jun. 20, 2019

Related U.S. Application Data
(60) Provisional application No. 62/437,964, filed on Dec. 22, 2016.

(51) Int. Cl. B05C 5/02; B05D 1/26

(52) U.S. Cl. CPC B05C 5/0262; B65H 27/00; B05C 5/0245; B05D 1/26

(57) ABSTRACT

A coating apparatus for a moving web that employs a spreader roller in the upweb position in a tensioned-web-over-slot die coater. The spreader roller can help spread webs laterally in a web processing operation, in particular to reduce or remove the presence of wrinkles or bagginess in the web. The spreader roller can be a reverse crown roll that is covered with a resilient material to assist spreading the web to remove wrinkles. The surface curvature of the spreader roller can be formed using layers of material such as a tape, to easily and readily approximate the shape of a reverse crown roll.

### BACKGROUND

Many products are often manufactured in a continuous web format for the processing efficiencies and capabilities that can be achieved with that approach. The term “web” is used here to describe thin materials which are manufactured or processed in continuous, flexible strip form. Illustrative examples include thin plastics, paper, textiles, metals, and composites of such materials.

Such operations often entail coating onto the web one or more layers of one or more fluids which may be subsequently dried or cured to form one or more layers of material coating(s) on the web. In continuous liquid coating processes, a liquid layer is applied through a coating applicator onto a moving web that is often in a form of a flexible plastic film. In many cases, a slot die is used to meter the coating fluid onto a moving web. Frequently, in such coating processes, the web is supported, by a roller or the like, at the point of application of the coating fluid to the web. However, positioning the coating applicator against an unsupported web can be effective in enabling coating of very thin liquid films. Thus, in some cases, rather than supporting the web by a roller or the like, the web is not physically supported at the point of application of the coating fluid by the slot die. Rather, the web is held in tension between a first roller located upweb from the slot die (i.e., the first roller is in contact with the uncoated web) and a second roller located downweb from the slot die (i.e., the second roller is in contact with the non-coated side of the coated web). The slot die is typically urged against the moving web impart tension to the web. The slot die has a first die lip, nearer the first roller, and a second die lip, nearer the second roller. In steady operation, the second die lip is prevented from contacting the moving web by the elastohydrodynamic force created by metering of the coating fluid onto the moving web. In some cases, depending on a large number of design factors, the first die lip is also prevented from contacting the moving web by these same forces. Thus, the web rides over the die lips, separated from the lips and lubricated by coating fluid itself. This coating technique is often referred to as Tensioned-Web-Over-Slot Die Coating.

One problem with Tensioned-Web-Over-Slot Die Coating is that it is effectively limited as to the width of the web which can be coated. The tension maintains the metering of the coating fluid quite precisely, but that only ensures that the amount of coating fluid applied to the web remains constant along the web's movement direction, often called the machine direction. Little about the workings of this coating method helps maintain constant metering of the coating fluid in the perpendicular in-plane direction on the web, often called the crossweb direction or the transverse direction. Numerous factors work against the goal of achieving good coating uniformity in the crossweb direction. Principle among these is so-called “baggy” web. Baggy web is web which does not lie down perfectly flat when a large but finite sheet is cut from the web and laid upon a perfectly flat surface, but rather, tends to contort, twist, pucker, or “bag”.

As a result, it is well-known in the industry that it is not possible to apply thin coatings of, for example, 1 micron thickness, with good crossweb uniformity on webs greater than 1 meter in width using Tensioned-Web-Over-Slot Die Coating, and the technique is typically used only for narrow webs, typically much narrower webs as are often encountered when working with converted roll stock (i.e., web material that has been slit, or converted, from one wide roll into several or many narrow-width stock rolls).

Gravure roll coating can sometimes be used to ensure good crossweb uniformity of coatings on webs, but gravure roll coating has the drawback that, as the coating thickness decreases, and the coating viscosity rises, the ability for the coating to flow sufficiently to relax out the “gravure marks” decreases. Thus, it is often impossible to make uniform 1 micron coatings on a 1 meter wide web with gravure coating as well.

There is a need in the web processing industry for an improved Tensioned-Web-Over-Slot Die Coating apparatus and method that can be productively used to apply thin coatings on wide moving webs of greater than 1 meter width, with excellent crossweb coating uniformity, even for reasonably baggy webs.

### SUMMARY

The present disclosure describes a Tensioned-Web-Over-Slot Die Coating apparatus and method that can be used to coat very thin coatings, with excellent crossweb uniformity, on webs greater than 1 meter in width. The coating apparatus improves on existing coating apparatus by using a special spreader roller as the first roller (i.e., upweb roller) in a Tensioned-Web-Over-Slot Die Coating apparatus to ensure that the web is in a highly flat configuration when fluid coating material is applied thereto via the slot die.

The present disclosure describes a spreader roller that can help spread webs laterally in a web processing operation, in particular to reduce or remove the presence of wrinkles or bagginess in the web in preparation for coating via a Tensioned-Web-Over-Slot slot die apparatus. The spreader roller can be a reverse crown roll that is covered with a resilient material to assist spreading the web to remove wrinkles. The surface curvature of the spreader roller can be formed using layers of material such as a tape, to easily and readily approximate the shape of a reverse crown roll. In one aspect, the present disclosure provides an apparatus for coating a moving web that includes a spreader roller that includes a reverse crown roll having a major surface, two ends, a midpoint halfway between the two ends, and a variable diameter that decreases from a first end diameter to a midpoint diameter, and increases from the midpoint diameter to a second end diameter; and an engagement cover comprising a resilient engagement surface, the engagement cover disposed over the major surface of the reverse crown roll. In one particular embodiment, the major surface is a stepped major surface, and the variable diameter decreases stepwise from the first end diameter to the midpoint and increases stepwise from the midpoint to the second end diameter. In another particular embodiment, the major surface is a stepped major surface that includes successive material layers of a tape, a sheet, a cord, a string, a wire, or a combination thereof.

In another aspect, the present disclosure provides an apparatus for coating a moving web that includes a spreader roller that includes a reverse crown roll including a roller having an outer surface, a first end and a second end, a midpoint having a midpoint diameter midway between the first end and the second end, and a variable outer diameter and a first material layer attached to the outer surface and extending in opposing directions from a first distance from the midpoint to the first end and from a second distance from the midpoint to the second end. The reverse crown roll further includes a second material layer attached to the first material layer and extending in opposing directions from a third distance from the midpoint to the first end, and from a fourth distance from the midpoint to the second end, wherein the third distance is greater than the first distance, and the fourth distance is greater than the second distance. The spreader roller further includes an engagement cover comprising a resilient engagement surface, the engagement cover disposed over the outer surface, the first material layer, and the second material layer.

In yet another aspect, the present disclosure provides an apparatus for coating a moving web that includes a spreader roller that includes a reverse crown roll having a major surface, two ends, a midpoint halfway between the two ends, and a variable diameter that decreases from a first end diameter to a midpoint diameter, and increases from the midpoint diameter to a second end diameter; and an engagement cover comprising a resilient engagement surface, the engagement cover disposed over the major surface of the reverse crown roll. In one particular embodiment, the major surface is a stepped major surface, and the variable diameter decreases stepwise from the first end diameter to the midpoint and increases stepwise from the midpoint to the second end diameter. In another particular embodiment, the major surface is a stepped major surface that includes successive material layers of a tape, a sheet, a cord, a string, a wire, or a combination thereof. The spreader roller being capable of rotating around an axis of rotation (which is parallel to the longitudinal axis of the roller); wherein the spreader roller is capable of spreading a web material in a crossweb direction essentially parallel to the axis of rotation while conveying the web material in a downweb direction perpendicular to the spreader roller axis of rotation.

In yet another aspect, the present disclosure provides an apparatus for coating a moving web that includes a spreader roller that includes a reverse crown roll including a roller having an outer surface, a first end and a second end, a midpoint having a midpoint diameter midway between the first end and the second end, and a variable outer diameter and a first material layer attached to the outer surface and extending in opposing directions from a first distance from the midpoint to the first end and from a second distance from the midpoint to the second end. The reverse crown roll further includes a second material layer attached to the first material layer and extending in opposing directions from a third distance from the midpoint to the first end, and from a fourth distance from the midpoint to the second end, wherein the third distance is greater than the first distance, and the fourth distance is greater than the second distance. The spreader roller further includes an engagement cover comprising a resilient engagement surface, the engagement cover disposed over the outer surface, the first material layer, and the second material layer. The spreader roller being capable of rotating around an axis of rotation; wherein the spreader roller is capable of spreading a web material in a crossweb direction essentially parallel to the axis of rotation while conveying the web material in a downweb direction perpendicular to the spreader roller axis of rotation.

In yet another aspect, the present disclosure provides a method for spreading a web that includes providing a spreader roller that includes a reverse crown roll having a major surface, two ends, a midpoint halfway between the two ends, and a variable diameter that decreases from a first end diameter to a midpoint diameter, and increases from the midpoint diameter to a second end diameter; and an engagement cover comprising a resilient engagement surface, the engagement cover disposed over the major surface of the reverse crown roll. In one particular embodiment, the major surface is a stepped major surface, and the variable diameter decreases stepwise from the first end diameter to the midpoint and increases stepwise from the midpoint to the second end diameter. In another particular embodiment, the major surface is a stepped major surface that includes successive material layers of a tape, a sheet, a cord, a string, a wire, or a combination thereof. The spreader roller being capable of rotating around an axis of rotation; providing a web material; conveying the web material in a downweb direction perpendicular to the axis of rotation; and contacting the moving web material with the engagement surface of the rotatable spreader roll, thereby spreading the web material in a crossweb direction essentially parallel to the axis of rotation.

In yet another aspect, the present disclosure provides a method for coating a moving web that includes providing a spreader roller that includes a reverse crown roll including a roller having an outer surface, a first end and a second end, a midpoint having a midpoint diameter midway between the first end and the second end, and a variable outer diameter and a first material layer attached to the outer surface and extending in opposing directions from a first distance from the midpoint to the first end and from a second distance from the midpoint to the second end. The reverse crown roll further includes a second material layer attached to the first material layer and extending in opposing directions from a third distance from the midpoint to the first end, and from a fourth distance from the midpoint to the second end, wherein the third distance is greater than the first distance, and the fourth distance is greater than the second distance. The spreader roller further includes an engagement cover comprising a resilient engagement surface, the engagement cover disposed over the outer surface, the first material layer, and the second material layer. The spreader roller being capable of rotating around an axis of rotation; providing a web material; conveying the web material in a downweb direction perpendicular to the axis of rotation; and contacting the moving web material with the engagement surface of the rotatable spreader roll, thereby spreading the web material in a crossweb direction essentially parallel to the axis of rotation.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A is a cross sectional view of an illustrative embodiment of a spreader roll;

FIG. 1B is a cross sectional view of another illustrative embodiment of a spreader roll;

FIG. 2A is a cross sectional view of an illustrative embodiment of a stepped reverse crown roll;

FIG. 2B is a cross sectional view of an illustrative embodiment of a stepped spreader roll;

FIG. 2C shows a cross sectional view of an illustrative embodiment of a stepped reverse crown roll; and

FIG. 3 is a schematic diagram of an illustrative embodiment of a coating apparatus.

The figures are not necessarily to scale. Like numbers used in the figures refer to like components. However, it will be understood that the use of a number to refer to a component in a given figure is not intended to limit the component in another figure labeled with the same number.

### Key and Glossary

The following terms are used herein as having the indicated meaning; other terms are defined elsewhere in the specification.

“Convey” is used to mean moving a web from a first position to a second position wherein the web passes through engaging contact with a roller.

“Engaging contact” is used to refer to contact between the web and the roller such that as the web is conveyed it engages with the engagement cover of the roller compressing the cover in response to contact with the web.

“Engagement surface” is the radially outwardly facing portion of the engagement cover that is directly contacted with the web when the web is conveyed.

“Engagement zone” is the portion of the engagement surface that is in direct contact with the web at a particular moment.

“Resilient” is used to refer to the capability of being deformed or compressed and then recovering to earlier shape or loft.

“Web” refers to a flexible, elongate ribbon or sheet of material.

The following abbreviations are used: “cm” for centimeter, “fpm” for feet per minute, “mm” for millimeter, and “mpm” for meters per minute.

Unless otherwise indicated, all numbers expressing feature sizes, amounts, and physical properties used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

### DETAILED DESCRIPTION OF ILLUSTRATIVE EMBODIMENTS

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

When a web (a thin substrate with considerable flexibility) travels past a slot die in a coating apparatus in a free span between two supporting rollers (i.e., the first supporting roller which conveys the web into coating position with the slot die head and the second supporting roller which conveys the web after it separates from coating position with the slot die head), the gap between the web and the coating applicator is determined primarily by the hydrodynamic stresses in the coating flow and externally applied tension on the web. The elastohydrodynamic interaction between the tensioned-web deformation and the viscous liquid flow in the coating bead has not been extensively studied for coating width that exceeds 1 meter due to non-uniformity in the plastic film. The present disclosure describes a novel coating apparatus which includes a spreader roller that can help spread webs laterally in a web processing operation, in particular to reduce or remove the presence of wrinkles or bagginess in the web. The spreader roller can be a reverse crown roll that is covered with a resilient material to assist spreading the web to remove wrinkles. The surface curvature of the spreader roller can be formed using layers of material such as a tape, to easily and readily approximate the shape of a reverse crown roll. The resulting reverse crown roll covered with a resilient material is a low cost method to achieve web spreading and can be used on most any cylindrical roll. In some cases, one of the benefits with using resilient materials on such fabricated reverse crown rolls is that the web centering requirement can be relaxed from the precise centering typically required when using a reverse crown roll without resilient material.

Coating apparatuses as described herein have been discovered to be capable of coating successfully with excellent crossweb uniformity on webs as wide as 1.0 meter, or even as wide as 1.25 meters, or even as wide as 1.5 meters, or even as wide as 2.0 meters, and it is believed that webs even wider could be coated successfully.

This is a surprising result. Many other types of conventional spreader rollers have been explored by applicants in the position of the second roller in a Tensioned-Web-Over-Slot Die Coater, and none have shown appreciable improvement over the use of a plain roller in that location (i.e., first supporting roller). Spreader rolls that have been tried and that have failed to lead to improved performance, include spiral rolls, crowned rolls, reverse crowned rolls, bowed rolls, and cambered rolls. The spreader rolls described in this disclosure provide unique performance improvement.

Thin film web materials can develop wrinkles during production or converting operations, and efforts to control or reduce this wrinkling often use spreader rolls to provide lateral tension to the web, thereby smoothing the wrinkles. Commonly available spreader rolls include bowed rollers, expanding surface rollers, rubber spreader rollers, grooved metal rollers, and reverse taper rollers. Reverse taper rollers (also commonly referred to as concave rolls, reverse crown rolls, or bow toe rolls) can be a preferred roll architecture to achieve effective web spreading. In many cases, the particular taper profile that may be most effective can vary depending on such parameters as the type of web material, web thickness, web speed and tension, and the web width being processed. For at least this reason, several different reverse taper rolls may need to be available to web-goods manufacturers or converters, which can lead to excessive costs.

Manufacturing thinner and more precise films requires greater and more precise control, such that defects including wrinkling and troughing during transport of the web over rollers are reduced. This becomes especially significant when optical quality web has any type of bagginess or skew. The variety of methods described above can work reasonably well when the web centerline or the web width does not vary significantly from product to product. However, since typical manufacturers or converters products can change web centerlines and widths, significant effort can be needed, such as the need to constantly adjust roll position or re-bumper (for example, apply thicknesses of tape to) the rolls.

The present disclosure provides for a coating apparatus having a spreader roller that enables weblines to coat wider films with thinner coatings at improved crossweb uniformity.

A resilient material can be used as a resilient engagement surface to provide for spreading to a web that contacts the engagement surface. The resilient engagement surface can cover a reverse crown roll or a roll which has been built up to approximate a reverse crown roll by using layers of a tape, a sheet, a cord, a string, a wire, or a combination thereof to take the shape of a reverse crown roll. In one particular embodiment, a vinyl or similar type tape can be preferred to build up the shape of a reverse crown roll. The resilient material can be a resilient looped pile, an open cell foam, a closed cell foam, or a combination thereof. In one particular embodiment, the resilient material can be a knit fabric comprising a base layer having first and second faces and a resilient looped pile protruding from the first face.

The web material will typically be provided in roll form, for example, wound upon itself or on a core, but may be provided in other configuration if desired. The present disclosure may be used with a wide variety of web materials, illustrative examples including plastics, paper, metal, and composite films or foils.

In some embodiments, the web material is provided from an intermediate storage state, for example, from an inventory of raw materials and/or intermediate materials. In other embodiments, the web material may be provided to the process of the present disclosure directly from precursor processing, for example, such as the take off feed from a film forming process. The web material may be single layer or multilayer, in some instances the described invention is used to convey the web material through manufacturing operations in one or more additional layers and/or one or more treatments are applied to a web material.

Configuring the web material into passing configuration simply refers to arranging the web material into position and orientation such that it can be put into engaging contact with the engagement surface of a roller in accordance with the disclosure. In many embodiments, this will simply comprise unrolling a portion of the web material which is in roll form such that it can be put into engaging contact with the engagement surface. In other illustrative embodiments, the web material is formed in a precursor portion of the operation, that is, in line, and passed directly into a web conveying apparatus without having been wound into roll form, for example, the polymeric material is extruded or cast in line to form a film which, at that point is in passing configuration without ever having been wound into roll form, is the web material conveyed by the apparatus of the disclosure.

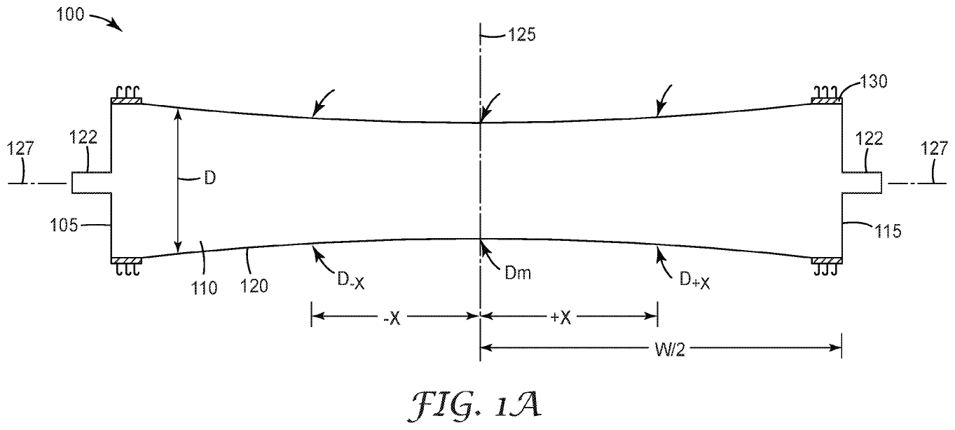

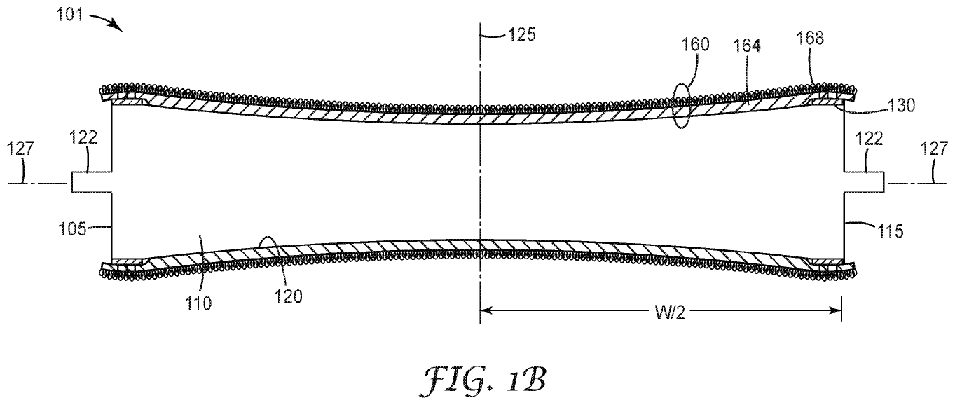

We turn first to descriptions of the spreader roller which serves as the first supporting roller of the inventive coating apparatus. FIG. 1A shows a cross sectional view of spreader roll 100 that can be a reverse crown roll 110 according to one aspect of the invention. Reverse crown roll 110 includes major surface 120, first end 105, opposing second end 115, and central shaft 122, and has axis of rotation 127 about which reverse crown roll 110 rotates. Optional attachment surface 130, for example a hooked material such as a 3M™ SCOTCHMATE™ Hook and Loop Reclosable Fastener material may be included near first and second ends 105, 115, for subsequent attachment of a resilient engagement surface, as described elsewhere.

Reverse crown roll 110 has midpoint 125 halfway between first and second ends 105, 115, half-width “W/2”, and variable diameter “D” that decreases from first end 105 to midpoint diameter “Dm” and increases again from midpoint diameter Dm to second end 115. In some cases, midpoint diameter Dm may be uniform for a portion of half-width W/2, and then increase. In some cases, the diameter at a distance (+/−X) from midpoint 125 (“D plus x” and “D minus x”, respectively) may be the same, that is, the roll can be symmetric about midpoint 125, although in some cases, the roll may be asymmetric, and the diameters may be different. The change in variable diameter D is exaggerated in FIG. 1A; typical variations in the diameter over half-width W/2 may be about 0.001 inch per inch of roller width (1 micrometer per cm of roller width), such that for a 6 foot (183 cm) half-width roller, the taper may be about 0.07 inch (1.78 mm), although in some cases the variation may be more. In one particular embodiment, the variation in the diameter may be greater when used with an engagement cover having a resilient engagement surface, as described elsewhere.

FIG. 1B shows a cross sectional view of spreader roller 101 that includes reverse crown roll 110 of FIG. 1A, according to one aspect of the invention. Each of elements 105-130 shown in FIG. 1B correspond to like-numbered elements shown in FIG. 1A, which have been described previously. For example, central shaft 122 in FIG. 1B corresponds to central shaft 122 in FIG. 1A, and so on. In FIG. 1B, reverse crown roll 110 is covered by disposing engagement cover 160 comprising a resilient engagement surface, over major surface 120 of reverse crown roll 110. In some cases, the resilient engagement surface comprises a resilient looped pile, an open cell foam, a closed cell foam, or a combination thereof. In one particular embodiment, engagement cover 160 includes a resilient engagement surface that is a knit fabric having base layer 164 having resilient looped pile 168 protruding from base layer 164. In the embodiment shown in FIG. 1B, engagement cover 160 is removable from reverse crown roll 110 and comprises base layer 164 and resilient looped pile 168 extending upwardly from the first face thereof to form the resilient engagement surface. The second face of base layer 164 is in contact with major surface 120 of reverse crown roll 110.

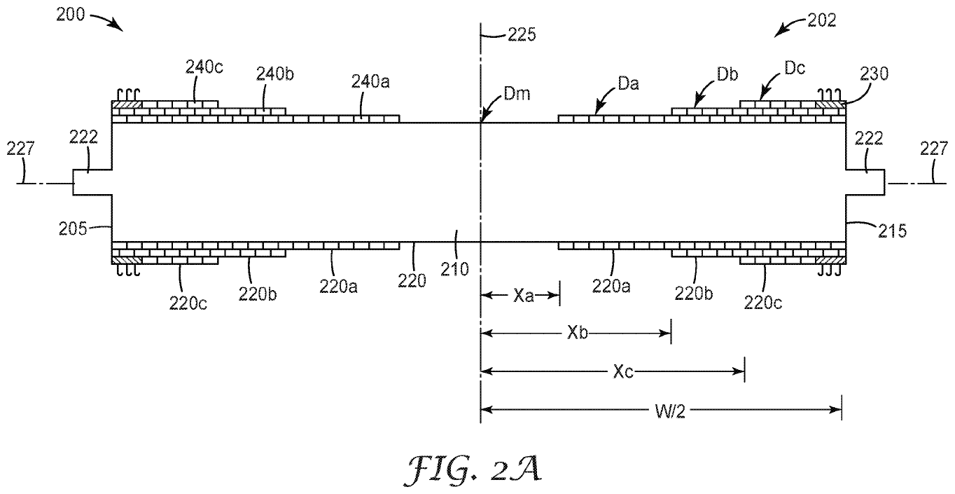

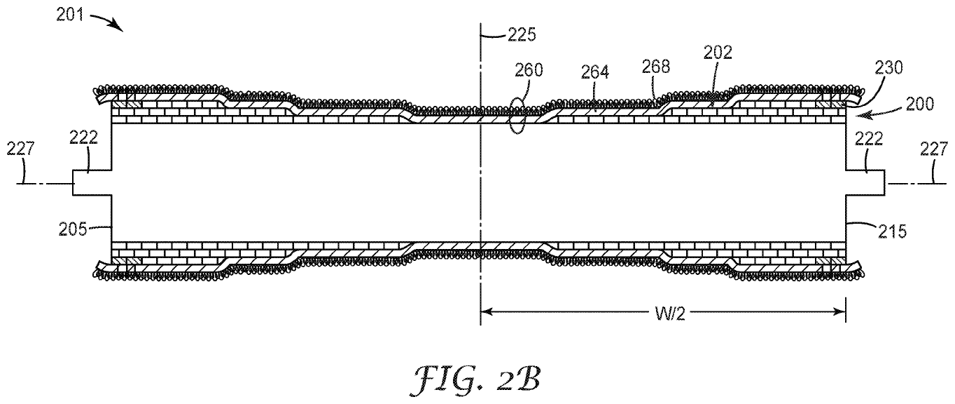

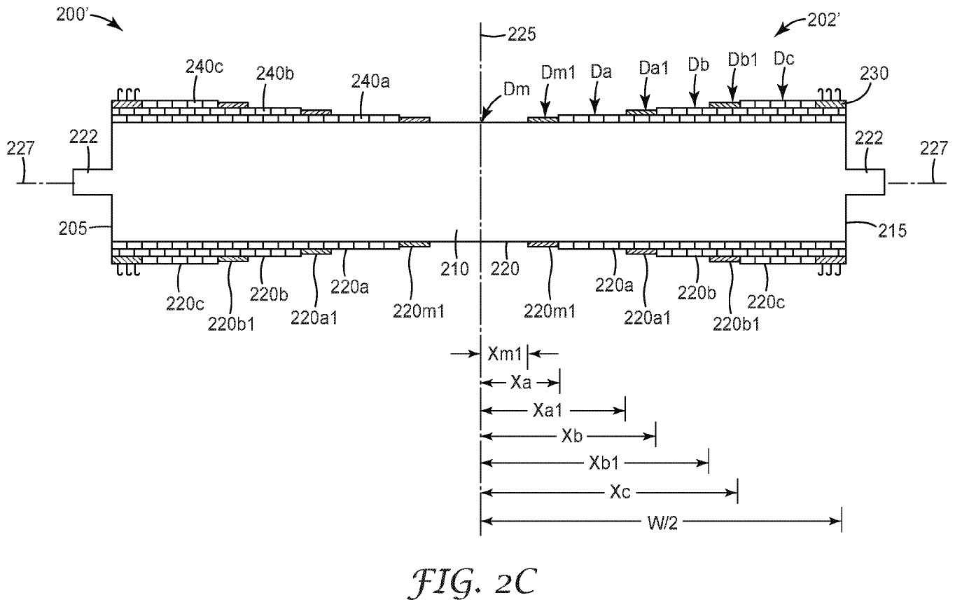

FIG. 2A shows a cross sectional view of a stepped reverse crown roll 200 that can be used as a spreader roller or a component of a spreader roll, according to one aspect of the invention. Stepped reverse crown roll 200 includes base roll 210 having base major surface 220, first end 205, opposing second end 215, central shaft 222 and axis of rotation 227 about which the base roll 210 rotates. Optional attachment surface 230, for example a hooked material such as a 3M™ SCOTCHMATE™ Hook and Loop Reclosable Fastener material may be included near first and second ends 205, 215, for subsequent attachment of a resilient engagement surface, as described elsewhere. In some cases, optional attachment surface 230 can be included over the stepped material layers as described below and shown in FIG. 2A; however, optional attachment surface 230 can instead be applied directly to base major surface 220 of base roll 210.

Base roll 210 has midpoint 225 halfway between first and second ends 205, 215, half-width W/2, and variable diameter D that decreases from first end 205 to midpoint diameter Dm and increases again from midpoint diameter Dm to second end 215. In some cases, midpoint diameter Dm may be a uniform diameter throughout half-width W/2, in which case base roll 210 is a cylindrical roller. In some cases, midpoint diameter Dm may be uniform for a portion of half-width W/2, for example to first distance “Xa” from midpoint 225, and then increase to first and second end 205, 215. In some cases, the midpoint diameter Dm may steadily increase from midpoint 225 to first and second ends 205, 215, such as in reverse crown roll 110 described with reference to FIG. 1A. In one particular embodiment, cylindrical base roll 210 can be preferred, where the midpoint diameter Dm does not vary from first end 205 to second end 215.

Stepped reverse crown roll 200 includes stepped major surface 202 that has a variable diameter that decreases stepwise from first end 205 to midpoint 225, and increases stepwise from midpoint 225 to second end 215. The stepwise changes in diameter can be inexpensive and rapid approximations to a machined reverse crown roll, such as reverse crown roll 110 shown in FIG. 1A. The changes in the diameter can be made by applying successive first material layers such as first layer 220a, second layer 220b, and third layer 220c, to base major surface 220 of base roll 210. It is to be understood that any desired number of first material layers can be applied to achieve the desired number of stepwise changes in the diameter. Each of successive first, second, and third layers 220a, 220b, 220c, can comprise individual sections of first materials 240a, 240b, 240c that can individually be selected from a tape, a sheet, a cord, a string, a wire, or the like, or a combination thereof. In one particular embodiment, a tape, such as an adhesive vinyl tape, can be preferred.

In one particular embodiment, each of successive first, second, and third layers 220a, 220b, 220c can be spirally wound around base roll 210, and in some cases adjacent spirally wound first material layers abut each other. In some cases, the adjacent spirally wound first material layers can abut each other such that no space remains between adjacent layers; however, in some cases, a space can remain between adjacent spirally wound first material layers. In one particular embodiment, each of successive first, second, and third layers 220a, 220b, 220c comprises a sheet that is circumferentially wound around base roll 210.

First layer 220a extends from first distance Xa from midpoint 225 to second distance Xb from midpoint 225, and results in first stepped diameter Da. Second layer 220b extends from second distance Xb from midpoint 225 to third distance Xc from midpoint 225, and results in a second stepped diameter Db. Third layer 220c extends from third distance Xc from midpoint 225 to half-width W/2 from midpoint 225, and results in third stepped diameter Dc. In this manner, stepped major surface 202 of stepped reverse crown roll 200 can approximate major surface 120 of reverse crown roll 110 shown in FIG. 1A, by comprising midpoint diameter Dm, first stepped diameter Da, second stepped diameter Db, and third stepped diameter Dc.

In some cases, first, second, and third distances Xa, Xb, and Xc, respectively, and any subsequent distances corresponding to additional layers (not shown) can be related as multiples of each other, or they may be spaced in some other manner, such as corresponding to any desired stepped profile that can aid in spreading the material to be processed. In some cases, each of the distances may be equally spaced, such that for example, (Xc−Xb)=(Xb−Xa), and so on. Further, in some embodiments, each of first, second, and third diameters Da, Db, and Dc, respectively, and any subsequent diameters corresponding to additional layers (not shown) may also increase by a constant amount or may increase by differing amounts such as corresponding to any desired stepped profile that can aid in spreading the material to be processed. The different diameters can result from more than one layer of material or by different thicknesses of material being added to form each layer. In one particular embodiment, a single layer of vinyl-backed adhesive tape can be used to form each of the layers. In some cases, the thickness of the single layer of vinyl-backed adhesive tape can be the same for each of the layers; in other cases, the thickness of each single layer of vinyl-backed adhesive tape can be different for at least one of the layers.

In some cases, stepped reverse crown roll 200 can be symmetric about midpoint 225, although in some cases, the roll may be asymmetric, and the stepped diameters may be different on each side of the midpoint, as known by one of skill in the art. The change in the stepped diameter is exaggerated in FIG. 2A; typical variations in the diameter over half-width W/2 may be about 0.001 inch per inch of roller width (1 micrometer per centimeter of roller width), such that for a 6 foot (183 cm) half-width roller, the taper may be about 0.07 inch (1.78 mm), although in some cases the variation may be more. In one particular embodiment, each first material layer has a thickness from about 0.025 mm to about 0.25 mm. In one particular embodiment, the variation in the diameter may be greater when used with an engagement cover having a resilient engagement surface, as described elsewhere.

FIG. 2B shows a cross sectional view of spreader roller 201 that includes stepped reverse crown roll 200 of FIG. 2A, according to one aspect of the invention. Each of elements 205-230 shown in FIG. 2B correspond to like-numbered elements shown in FIG. 2A, which have been described previously. For example, central shaft 222 in FIG. 2B corresponds to central shaft 222 in FIG. 2A, and so on. In FIG. 2B, stepped reverse crown roll 200 is covered by disposing engagement cover 260 comprising a resilient engagement surface, over stepped major surface 202 of stepped reverse crown roll 200. In some cases, the resilient engagement surface comprises a resilient looped pile, an open cell foam, a closed cell foam, or a combination thereof. In one particular embodiment, engagement cover 260 includes a resilient engagement surface that is a knit fabric having base layer 264 having resilient looped pile 268 protruding from base layer 264. In the embodiment shown in FIG. 2B, engagement cover 260 is removable from stepped reverse crown roll 200 and comprises base layer 264 and resilient looped pile 268 extending upwardly from the first face thereof to form the resilient engagement surface. The second face of base layer 264 is in contact with stepped major surface 202 of stepped reverse crown roll 200.

FIG. 2C shows a cross sectional view of stepped reverse crown roll 200′ that can be used as a spreader roller or a component of a spreader roll, according to one aspect of the invention. Stepped reverse crown roll 200′ can be covered by disposing an engagement cover comprising a resilient engagement surface, over stepped major surface 202′ of stepped reverse crown roll 200′, in a manner similar to that shown in FIG. 2B. Each of elements 205-230 shown in FIG. 2C correspond to like-numbered elements shown in FIG. 2A, which have been described previously. For example, central shaft 222 in FIG. 2C corresponds to central shaft 222 in FIG. 2A, and so on. In FIG. 2C, smaller step changes in the diameter can be made by applying successive second material layers adjacent the stepped major surface, wherein the second material layer has a thickness that is less than the thickness of the first material layer.

In one particular embodiment, fourth layer 220m1, fifth layer 220a1, and sixth layer 220b1, are applied on top of base major surface 220, first layer 220a, and second layer 220b, respectively. Each of fourth, fifth, and sixth layers 220m1, 220a1, 220b1, can comprise individual sections of second materials that can individually be selected from a tape, a sheet, a cord, a string, a wire, or the like, or a combination thereof. In one particular embodiment, a tape, such as an adhesive vinyl tape, can be preferred.

In one particular embodiment, each of fourth, fifth, and sixth layers 220m1, 220a1, 220b1 can be spirally wound in a manner similar to first, second, and third layers 220a, 220b, 220c, or can even comprise a sheet that is circumferentially wound as described elsewhere.

Fourth layer 220m1 extends from fourth distance “Xm1” from midpoint 225 to first distance Xa from midpoint 225, and results in fourth stepped diameter “Dm1”. Fifth layer 220a1 extends from fifth distance Xa1 from midpoint 225 to second distance Xb from the midpoint 225, and results in fifth stepped diameter Da1. Sixth layer 220b1 extends from sixth distance Xb1 from midpoint 225 to the third distance Xc from midpoint 225, and results in sixth stepped diameter Db1. In this manner, stepped major surface 202′ of stepped reverse crown roll 200′ can more closely approximate major surface 120 of reverse crown roll 110 shown in FIG. 1A, by comprising midpoint diameter Dm, fourth stepped diameter Dm1, first stepped diameter Da, fifth stepped diameter Da1, second stepped diameter Db, the sixth stepped diameter Db1, and third stepped diameter Dc.

In some cases, stepped reverse crown roll 200′ can be symmetric about midpoint 225, although in some cases, the roll may be asymmetric, and the stepped diameters may be different on each side of the midpoint, as known by one of skill in the art. The change in the stepped diameter is exaggerated in FIG. 2C; typical variations in the diameter over half-width W/2 may be about 0.001 inch per inch of roller width (1 micrometer per centimeter of roller width), such that for a 6 foot (183 cm) half-width roller, the taper may be about 0.07 inch (1.78 mm), although in some cases the variation may be more. In one particular embodiment, each material layer has a thickness from about 0.025 mm to about 0.25 mm. In one particular embodiment, the variation in the diameter may be greater when used with an engagement cover having a resilient engagement surface, as described elsewhere.

Each of the spreader rolls described herein can be used in a web coating apparatus to reduce or eliminate sagging and bagging of a thin web during processing.

An advantage of the present invention is that typically engagement covers may be readily installed on existing spreader rollers without significant equipment change or significant reconfiguration of apparatus components. Also, spreader rollers described herein may be readily installed on existing Tensioned-Web-Over-Slot Die Coaters. Thus, existing web coating apparatuses may be readily refit with engagement covers or entire spreader rollers of the invention to achieve attendant improvements in performance.

The manner in which the engagement cover is mounted on a spreader roller is dependent upon such factors as the configuration of the apparatus and rollers, for example, in some instances a roller must be removed from its operational location in order to have an engagement cover mounted thereon whereas in other instances the cover can be installed with the roll in operating position.

During operation, the engagement cover should not slide or stretch on the underlying roller as this can lead to wear of various components of the apparatus, damage to the web, or other impairment of performance. In many instances, when the engagement cover is simply a knit fabric as described herein and has a snug fit to the surface of the underlying roller, the second face of the engagement cover will remain firmly positioned on the roller during operation. In some instances, mounting means such as an intermediate adhesive, mated hook and loop fasteners, rigid shell which attaches to the roller, etc. will be used. In some instances, multiple engagement covers of the invention are installed on a single roller, mounted concentrically on the roller with the engagement surface of each orientated outward or away from the roller.

In preferred embodiments, the engagement cover is knit fabric as described in, for example, co-pending PCT Publication Nos. WO2011/038279 (Tait et al.) and WO2011/038284 (Newhouse et al.), and which can be mounted on the roller as a removable sleeve. The sleeve is preferably seamless and should be of appropriate size to fit around roller snugly without developing any loose bulges or ridges. In many embodiments, the sleeve will be configured to extend beyond both ends of the roller sufficiently far that it can be cinched and tied; if the sleeve is of appropriate dimension this action typically tends to pull the sleeve tight. Typically the sleeve should be at least as wide as the web, preferably wider than the web to ease concerns about alignment of the traveling web.

Mounting the engagement cover on the roller may be achieved by conventional means dependent in part upon the nature of the engagement cover and that of the conveying apparatus. Preferably the engagement cover does not slide on the roller core during operation. In many embodiments, the cover is in the form of a sleeve that fits snugly on the roller, optionally extending beyond the ends of the roller sufficiently to be cinched there. In some embodiments, the engagement cover and surface of the roller exhibit sufficient frictional effect, in some instances additional means such as adhesive or hook and loop type fastener mechanisms may be used.

While it is typically desirable for the base of a sleeve of the engagement cover to stretch so as to achieve a snug fit on the spreader roll, the base should not stretch during operation so as to cause bunching underneath the web being conveyed. Alternatively, rollers may be manufactured with engagement covers as described herein being more strongly attached to the outer surface thereof. Further, an advantage of removable embodiments is that it will typically be easier and cheaper to replace removable engagement covers on a roller to replace the engagement surface of rather than refinishing a roller having an integrated engagement surface in accordance with the disclosure.

In a typical embodiment, the cover is made with a knit fabric having a pile-forming loop at every stitch. In an illustrative embodiment there are 25 stitches per inch (1 stitch per millimeter). The fibrous material(s) used to make the fabric may be single filament strands, multifilament strands (for example, two or more strands wound together to yield a single thread), or combinations thereof.

In many embodiments, the looped pile has a loop height (that is, dimension from the plane defined by the top of the base layer to the apex of the pile loops) of from about 0.4 to about 2.2 mm, preferably from about 0.5 to about 1.5 mm. It will be understood that engagement covers having looped pile having loop heights outside this range may be used in certain embodiments. If the loop height is insufficient, the cover may fail to provide effective cushioning effect to the web to achieve the full benefits of the disclosure. If the loop height is too high, the pile may tend to get floppy and undesirably affect web transport or damage the conveyed web.

The pile should be sufficiently dense to be supportive of the web during conveying so as to reliably achieve the benefits of the disclosure. For instance, the looped pile comprises fibers selected to have an appropriate denier for the application, with thicker fibers providing relatively greater resistance to compression. Illustrative examples include fibers having a denier from about 50 to about 500, preferably from 50 to 200, more preferably from 50 to 150. As will be understood, fibers having a denier outside this range may be used in some embodiments in accordance with the disclosure.

In illustrative embodiments, the fibrous material(s) can be selected from the group consisting of poly(tetrafluoroethylene) (“PTFE”, for example, TEFLON® fiber), aramid (for example, KEVLAR® fiber), polyester, polypropylene, nylon, or combinations thereof. Fibrous materials made from chemically-similar polymers as the films being processed may be preferred. Thus, for a coater used for coating onto a polyester film web, polyester fibers may be preferred for the fibrous material of the spreader roller. However, those skilled in the art will be able to readily select other fibers which can be effectively knit and used in covers of the disclosure.

The base is typically knit so as to provide the desired properties to permit it to be placed on a roller and used in accordance with the disclosure, for example, stretch and slide sufficiently easily over the roll to permit it to be installed while not stretching undesirably during operation.

Some illustrative examples of materials that can be used as sleeves to make engagement covers of the disclosure include: HS4-16 and HS6-23 polyester sleeves from Syfilco Ltd., Exeter, Ontario, Canada; WM-0401C, WM-0601, and WM-0801 polyester sleeves from Zodiac Fabrics Company, London, Ontario, Canada or its affiliate Carriff Corp., Midland, N.C.; and BBW3310TP-9.5 and BBW310TP-7.5 sleeves from Drum Filter Media, Inc., High Point, N.C.

Typically, knit fabrics are made using fibrous materials that have been treated with lubricants to facilitate the knitting process. When the resultant knit fabrics are used in web conveyance operations in accordance with the disclosure, such lubricants may tend to wear away causing variation in frictional performance to the web and potential contamination issues. Accordingly, it is typically preferred to wash or scour fabrics used as roller covering herein.

The material(s) selected should be compatible with the web materials and operating conditions, for example, stable and durable under the ambient operating conditions, for example, temperature, humidity, materials present, etc. It has been observed that, if the engagement cover material(s) are of contrasting color to the web materials, observation of debris capture by the engagement cover is facilitated, for example, using black polyester fibers in an engagement cover to be used with a transparent film web.

Typically, because of the requirements of the knitting processes used to make them, knit fabrics are made with fibrous materials that have limited elastomeric character so that the fibers can be moved around in contact with one another to form the desired knit. In many instances, lubricants are applied to the fibers to facilitate the knitting process. It is preferred to remove such lubricants from knits used in the present disclosure, for example, by cleaning or scouring the material such as by washing it before using it. In some instances, the knit can be put into service as an engagement surface of the disclosure with a lubricant being worn away.

Typically it is preferred that the loop pile of the engagement cover provide a coefficient of friction to the web of from about 0.25 to about 2, with about 1.0 or more often being preferred, though engagement covers providing coefficients of friction outside this range may be used if desired.

The degree of grip or coefficient of friction (“COF”) which is desired of the engagement surface to the web is dependent in part upon the function of the subject roller. For instance, in the case of an idler roller or other roller operating under little tension differential, a lower COF is typically satisfactory. In the case of driven rollers, especially highly driven rollers operating under a large tension differential a higher COF is typically desired.

In some cases, in order to simultaneously achieve desired frictional properties with the web, abrasion resistance, radial modulus of elasticity, and resilience of the loop pile, quantities of selected polymeric relatively elastomeric (as compared to the fibrous pile material(s)) materials can be applied to the engagement surface to form grip enhancement elements that raise the effective COF between the engagement surface and web, if desired.

The described invention may be used with known web transport spreader rollers, including for example, rubber rollers, metal rollers (for example, aluminum, steel, tungsten, etc.), and composite rollers. Rollers may be solid or hollow and may include such apparatus to apply vacuum effects, heating the web, cooling the web, etc. Surprisingly, the spreader rollers having a resilient engagement cover can accommodate mismatches in placement of the web, for example, the centerline of the web may be displaced from the midpoint of the spreader roller and still provide spreading and smoothing of the web.

As noted above, in some instances, an apparatus may comprise rollers with multiple engagement covers installed thereon, mounted concentrically on a roller. This may be done to yield a thicker cushion depth, thus increasing the dampening effect of the engagement cover(s). Also, in some instance, particularly in large industrial settings, significantly more effort is required to install an engagement cover on a roller than is necessary to remove it from the roller. Thus, if multiple engagement covers are installed on a roller, once the outer one is contaminated and/or worn from use, the outer engagement cover can be removed to expose an underlying engagement cover for significantly less cost and effort than freshly installing a new cover.

The spreader rolls can be used in connection with a wide variety of web materials. It is well suited and can provide particular advantage in connection with the manufacture and handling of webs of high quality polymeric materials such as optical films. Such films, typically comprising one or more layers of select polymeric materials, for example, radiation-cured compositions, typically require precise and uniform specifications of width, thickness, film properties, etc. with very low defect rates. The web material may be of monolayer or multilayer construction.

In some embodiments, the web is a simple film, for example, of polyester (for example, photograde polyethylene terephthalate and MELINEX™ PET from DuPont Films) or polycarbonate. In some embodiments, the film comprises such materials as, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, and polyimides.

The engagement covers described herein have a low radial modulus of elasticity with enhanced tribological characteristics. As a result, the disclosure provides a convenient, low cost way to reduce undesirable effects on the web during web coating.

The engagement covers provide a resilient low radial modulus of elasticity character to the roller surface which compensates for many pertubations encountered in a complex web transport system, for example, tension variations and speed variations, due to any of a myriad of causes, for example, variation in web properties such as thickness, modulus, etc., variations in performance or characteristics of individual rolls in a system comprising many rolls, power fluctuations in drive rolls, and the like. In accordance with the disclosure, the covers enable the web to avoid buckling and wrinkling when it otherwise might. In addition, the cover has been found to dampen velocity and tension variability of the web as it travels through the web line. As a result, high quality webs, for example, optical grade webs, can be processed at high speeds, for example, 100 fpm (30.5 mpm), 150 fpm (46 mpm), 170 fpm (52 mpm), or more, with reduced web degradation, for example, buckling, scuffing, etc. Furthermore, the pile construction is believed to entrap contamination, for example, dirt particles, that would otherwise damage the web being processed.

The spreader rolls described herein may be used on web coating apparatus having just one or two rolls, or systems having many more rolls. The engagement covers may be used on one or two selected spreader rolls in a system or in many, or even all, rolls throughout the system as desired.

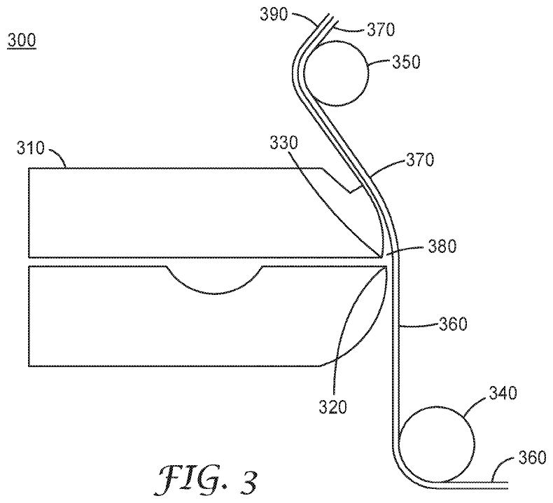

Turning now to FIG. 3, coating apparatus 300 is shown schematically. Slot die 310 has first die lip 320 and second die lip 330. First supporting roller 340 is positioned upweb from slot die 310 so that it is nearer first die lip 320 than to second die lip 330. Second supporting roller 350 is positioned downweb from slot die 310 so that it is nearer second die lip 330 than to first die lip 320. Uncoated web 360 travels over first roller 340 and passes in proximity to slot die 310. Uncoated web 360 becomes coated web 370 when coating fluid 380 is metered onto it by slot die 310. Note that slot die 310 is positioned relative to first supporting roller 340 and second supporting roller 350 such that web 360, 370 cannot take a straight-line path from first supporting roller 340 to second supporting roller 350. This provides at least a part of the tension in the web. However, coated film 370 does not come in contact with die lip 330 of slot die 310 because it rides on a cushion of coating fluid 380. In some cases, this coating cushion also prevents uncoated web 360 and coated web 370 from coming into contact with first die lit 320 of slot die 310. Coating 390 is deposited on coated web 370 and travels with it to second supporting roller 350. The side of the web away from coating 390 contacts the second supporting roller 350. First supporting roller 340 can be any type of the spreader roller described throughout this disclosure. In typical embodiments, first supporting roller 340 is positioned at a distance of from about 1 inch (2.5 centimeters) to about 4 inches (10 centimeters) from the slot die. First supporting roller 340 and second supporting roller 350 are typically oriented relative to one another such that their respective longitudinal axes are substantially parallel to one another and serve to support web 360, 370 in desired relative position and orientation to slot die 310.

### EXAMPLES

The invention may be further understood with reference to the following illustrative examples.

### Example 1

A Tensioned-Web-Over-Slot Die Coating apparatus as shown schematically in FIG. 3 was used. First supporting roller 340 was prepared as follows.

The technique for producing a spreader roller as described herein began with a measurement of the length of an ordinary cylindrical roll. The roll was measured as 1.27 meters long. For a stepped roller of the type shown in FIGS. 2A-2C, experience has shown that step widths of up to 18 cm are effective. Spreader rollers with incrementally longer step widths tend to perform incrementally less well. On the other hand, when step width is reduced, performance does not suffer, but the complexity and effort needed to prepare the stepped roller increases. So step widths of at least 11 cm are preferred, though not required. For this roller, it was decided to leave a 12.7 cm unwrapped portion in the center. The step widths, going outward, symmetrically, from the center, were 11.4 cm, 14.4 cm, 14.4 cm, and 14.4 cm. 2.5 cm was left unwrapped at each end.

The roll was then spiral wrapped with 3M™ vinyl tape 471 (3M, St. Paul, Minn.) on one side of the roller. The 2.5 cm unwrapped portions at each end were left to accommodate the attachment of 3M™ SCOTCHMATE™ (3M, St. Paul, Minn.) hook material, which was placed adjacent the ends. The second layer of tape was wrapped over the first layer of tape beginning at the spacing distance previously determined, then the third over the second, and so on. Attempts were made to straddle any gaps left between the spiral windings of the first layer of tape and make any spacing adjustments that were necessary to ensure relatively gap-free spiral windings. The wrapping process was then repeated on the other half of the roller. A tubular shaped resilient engagement surface material was cut to about 1.5 times the length of the roll and slid onto the roll. The hook material was then added to the 2.5 cm spaces left at the ends of the roll. The hook material had an adhesive backing for attaching it to the roll. Then the tubular shaped resilient engagement surface was stretched and attached to the hook material on both ends and any excess material was trimmed off. The tubular shaped resilient engagement surface could be disengaged from the hook material and slid back across the roll to make any tape adjustments to the stepping deemed necessary to improve results. The tubular resilient engagement surface material used to cover the roll had a 100 denier polyester resilient loop pile, with a loop height of 1.5 mm.

A standard biaxially oriented PET film of approximately 1.2 meters width was coated with a solvent-based silicone coating, targeting a 1 micron finished coating thickness. The coating line was run at rates in excess of 300 meters/min. Coating quality was deemed uniform enough for commercial production across the width of the film.

### Example 2

The procedure of Example 1 was followed, with one exception: The polyester for the resilient loop pile was 144 denier. Coating quality was deemed uniform enough for commercial production across the width of the film.

### Example 3

The procedure of Example 1 was followed with one exception: The polyester resilient loop pile had a loop height of 2.2 mm. Coating quality was deemed uniform enough for commercial production across the width of the film.

### Comparative Example 1

The procedure of Example 1 was followed with two exceptions: The polyester for the resilient loop pile was 144 denier, and the polyester resilient loop pile had a loop height of 2.2 mm. Coating quality was deemed not uniform enough for commercial production across the width of the film.

### Example 4

The procedure of Example 1 was followed, with one exception: The film to be coated was a standard biaxially oriented polyethylene naphthalate (“PEN”) film. Coating quality was deemed uniform enough for commercial production across the width of the film.

### Example 5

The procedure of Example 1 was followed, with one exception: The film to be coated was a standard biaxially oriented polylactic acid (“PLA”) film. Coating quality was deemed uniform enough for commercial production across the width of the film.

### Example 6

The procedure of Example 1 was followed, with one exception: The film to be coated was a standard biaxially oriented multilayer optical film (“MOF”) mirror film having polyester skins. Coating quality was deemed uniform enough for commercial production across the width of the film.

### Example 7

The procedure of Example 1 was followed, with one exception: The film to be coated was a standard uniaxially oriented MOF polarizer film having polyester skins. Coating quality was deemed uniform enough for commercial production across the width of the film.

### Comparative Example 2

The procedure of Example 1 was followed, with one exception: The film to be coated was a standard biaxially oriented polypropylene film (“BOPP”). Coating quality was deemed not uniform enough for commercial production across the width of the film.

### PARTICULAR EMBODIMENTS

Illustrative embodiments of the present disclosure include the following:

### Embodiment 1

An apparatus for coating a moving web, comprising:
a slot die;
a first roller positioned so as to be in contact with the moving web prior to it being coated from the slot die, the first roller and slot die being on opposite side of the moving web; and
a second roller positioned so as to be in contact with the non-coated side of the moving web after it being coated;
   wherein the second roller comprises:
a reverse crown roll having a major surface, two ends, a midpoint halfway between the two ends, and a variable diameter that decreases from a first end diameter to a midpoint diameter, and increases from the midpoint diameter to a second end diameter; and
an engagement cover comprising a resilient engagement surface, the engagement cover disposed over the major surface of the reverse crown roll.

### Embodiment 2

The apparatus of Embodiment 1, wherein the major surface is a stepped major surface, and the variable diameter decreases stepwise from the first end diameter to the midpoint and increases stepwise from the midpoint to the second end diameter.

### Embodiment 3

The apparatus of Embodiment 1, wherein the major surface is a stepped major surface comprising successive material layers of a tape, a sheet, a cord, a string, a wire, or a combination thereof.

### Embodiment 4

The apparatus of Embodiment 3, wherein the material layers are sequentially applied to a base roll surface.

### Embodiment 5

The apparatus of Embodiment 4, wherein the base roll surface includes a uniform diameter.

### Embodiment 6

The apparatus of Embodiment 3, wherein each material layer has a first thickness from about 0.025 mm to about 0.25 mm.

### Embodiment 7

The apparatus of Embodiment 3, further comprising a second material layer disposed adjacent the stepped major surface, the second material layer having a second thickness that is less than a first material thickness.

### Embodiment 8

The apparatus of Embodiment 4, wherein each material layer comprises a spirally wound tape around the base roll surface.

### Embodiment 9

The apparatus of Embodiment 4, wherein each material layer comprises a sheet that is circumferentially wound around the base roll surface.

### Embodiment 10

The apparatus of Embodiment 8, wherein adjacent spirally wound tape layers abut each other.

### Embodiment 11

The apparatus of Embodiment 3, wherein a first material layer is applied on a uniform diameter base roll surface, extending from a first distance from the midpoint to a first end, and also extending in an opposite direction from a second distance from the midpoint to a second end.

### Embodiment 12

The apparatus of Embodiment 11, wherein each subsequent material layer is applied extending from a subsequent layer distance from the midpoint to the respective end, wherein the subsequent layer distance is greater than an underlying layer distance from the midpoint.

### Embodiment 13

The apparatus of Embodiment 1, wherein the resilient engagement surface comprises a resilient looped pile, an open cell foam, a closed cell foam, or a combination thereof.

### Embodiment 14

The apparatus of Embodiment 1, wherein the resilient engagement surface is a knit fabric comprising a base layer having first and second faces and a resilient looped pile protruding from the first face.

### Embodiment 15

The apparatus of Embodiment 14, wherein the base layer comprises a woven base layer, a knitted base layer, a non-woven base layer, or a combination thereof.

### Embodiment 16

The apparatus of Embodiment 1, wherein the engagement cover attaches to the major surface of the reverse crown roll by compression, adhesion, mechanical attachment, or a combination thereof.

### Embodiment 17

The apparatus of Embodiment 1, wherein the engagement cover comprises a tube shape or a rectangle shape.

### Embodiment 18

The apparatus of Embodiment 13, wherein the resilient looped pile comprises a fibrous material selected from poly(tetrafluoroethylene), aramid, polyester, polypropylene, nylon, or a combination thereof.

### Embodiment 19

The apparatus of Embodiment 13, wherein the resilient looped pile comprises a fibrous polyester material.

### Embodiment 20

The apparatus of Embodiment 13, wherein the resilient looped pile comprises a fibrous material having a loop height not greater than 1.5 mm and a denier not greater than 144.

### Embodiment 21

The apparatus of Embodiment 13, wherein the resilient looped pile comprises a fibrous material having a loop height not greater than 2.2 mm and a denier not greater than 100.

### Embodiment 22

The apparatus of Embodiment 1, wherein the spreader roller comprises at least two engagement covers concentrically disposed over the major surface of the reverse crown roll.

### Embodiment 23

An apparatus for coating a moving web, comprising:
a slot die;
a first roller positioned so as to be in contact with the moving web prior to its being coated; and
a second roller positioned so as to be in contact with the non-coated side of the moving web after its being coated;
   wherein the second roller comprises a reverse crown roll comprising:
a roller having an outer surface, a first end and a second end, a midpoint having a midpoint diameter midway between the first end and the second end, and a variable outer diameter;
a first material layer attached to the outer surface and extending in opposing directions from a first distance from the midpoint to the first end and from a second distance from the midpoint to the second end;
a second material layer attached to the first material layer and extending in opposing directions from a third distance from the midpoint to the first end, and from a fourth distance from the midpoint to the second end, wherein the third distance is greater than the first distance, and the fourth distance is greater than the second distance; and
an engagement cover comprising a resilient engagement surface, the engagement cover disposed over the outer surface, the first material layer, and the second material layer.

### Embodiment 24

The apparatus of Embodiment 23, wherein the first distance and the second distance are approximately equal, and the third distance and the fourth distance are approximately equal.

### Embodiment 25

The apparatus of Embodiment 23, wherein the first material layer and the second material layer each comprise a tape, a sheet, a cord, a string, a wire, or a combination thereof.

### Embodiment 26

The apparatus of Embodiment 23, wherein each material layer has a first thickness from about 0.025 mm to about 0.25 mm.

### Embodiment 27

The apparatus of Embodiment 23, wherein each material layer comprises a tape that is spirally wound around the outer surface.

### Embodiment 28

The apparatus of Embodiment 23, wherein each material layer comprises a sheet that is circumferentially wound around the outer surface.

### Embodiment 29

The apparatus of Embodiment 27, wherein adjacent spirally wound tape layers abut each other.

### Embodiment 30

The apparatus of Embodiment 23, wherein subsequent material layers are applied extending from a subsequent layer distance from the midpoint to the respective end, wherein the subsequent layer distance is greater than an underlying layer distance from the midpoint.

### Embodiment 31

The apparatus of Embodiment 23, wherein the resilient engagement surface comprises a resilient looped pile, an open cell foam, a closed cell foam, or a combination thereof.

### Embodiment 32

The apparatus of Embodiment 23, wherein the resilient engagement surface is a knit fabric comprising a base layer having first and second faces and a resilient looped pile protruding from the first face.

### Embodiment 33

The apparatus of Embodiment 32, wherein the base layer comprises a woven base layer, a knitted base layer, a non-woven base layer, or a combination thereof.

### Embodiment 34

The apparatus of Embodiment 23, wherein the engagement cover attaches to the outer surface of the reverse crown roll by compression, adhesion, mechanical attachment, or a combination thereof.

### Embodiment 35

The apparatus of Embodiment 23, wherein the engagement cover comprises a tube shape or a rectangle shape.

### Embodiment 36

The apparatus of Embodiment 32, wherein the resilient looped pile comprises a fibrous material selected from poly(tetrafluoroethylene), aramid, polyester, polypropylene, nylon, or a combination thereof.

### Embodiment 37

The apparatus of Embodiment 32, wherein the resilient looped pile comprises a fibrous polyester material.

### Embodiment 38

The apparatus of Embodiment 32, wherein the resilient looped pile comprises a fibrous material having a loop height not greater than 1.5 mm and a denier not greater than 144.

### Embodiment 39

The apparatus of Embodiment 32 wherein the resilient looped pile comprises a fibrous material having a loop height not greater than 2.2 mm and a denier not greater than 100.

### Embodiment 40

The apparatus of Embodiment 23, wherein the spreader roller comprises at least two engagement covers concentrically disposed over the outer surface of the reverse crown roll.

### Embodiment 41

The apparatus of any of the preceding Embodiments, wherein the slot die, the first roller, and the second roller are each at least 1 meter wide, as measured in the direction perpendicular to the direction of a web to be coated.

### Embodiment 42

A method for coating a moving web, comprising:
providing an apparatus according to Embodiment 1 or Embodiment 23:
providing a web material;
providing a fluid coating material;
conveying the web material in a downweb direction such that it first contacts the first roller of the apparatus; then passes proximate to the slot die; and then contacts the second roller; and
metering the fluid coating material from the slot die onto the web material;
wherein the web material passing proximate to the slot die is kept from contact with the slot die only by the elastohydrodynamic force created by the metering of the fluid coating material from the slot die onto the web material.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An apparatus for coating a moving web, said web comprising a film selected from the group consisting of: bi-axially oriented PET, bi-axially oriented PEN, bi-axially oriented PLA, bi-axially oriented MOF and uni-axially oriented MOF, said apparatus comprising:
a slot die;
a first roller positioned so as to be in contact with the moving web prior to it being coated from the slot die, the first roller and slot die being on opposite side of the moving web; and
a second roller positioned so as to be in contact with the non-coated side of the moving web after it being coated;
wherein the second roller comprises:
a reverse crown roll having a major surface, two ends, a midpoint halfway between the two ends, and a variable diameter that decreases from a first end diameter to a midpoint diameter, and increases from the midpoint diameter to a second end diameter; and
an engagement cover comprising a resilient engagement surface, the engagement cover disposed over the major surface of the reverse crown roll, wherein the resilient engagement surface comprises a resilient looped pile, and the resilient looped pile comprises a fibrous material having a loop height not greater than 1.5 mm and a denier not greater than 144.

2. The apparatus for coating a moving web of claim 1, wherein the major surface is a stepped major surface, and the variable diameter decreases stepwise from the first end diameter to the midpoint and increases stepwise from the midpoint to the second end diameter.

3-13. (canceled)

14. The apparatus for coating a moving web of claim 1, wherein the resilient engagement surface is a knit fabric comprising a base layer having first and second faces and a resilient looped pile protruding from the first face.

15. The apparatus for coating a moving web of claim 14, wherein the base layer comprises a woven base layer, a knitted base layer, a non-woven base layer, or a combination thereof.

16. The apparatus for coating a moving web of claim 1, wherein the engagement cover attaches to the major surface of the reverse crown roll by compression, adhesion, mechanical attachment, or a combination thereof.

17. The apparatus for coating a moving web of claim 1, wherein the engagement cover comprises a tube shape or a rectangle shape.

18. The apparatus for coating a moving web of claim 13, wherein the resilient looped pile comprises a fibrous material selected from poly(tetrafluoroethylene), aramid, polyester, polypropylene, nylon, or a combination thereof.

19. The apparatus for coating a moving web of claim 13, wherein the resilient looped pile comprises a fibrous polyester material.

20-21. (canceled)

22. The apparatus for coating a moving web of claim 1, wherein the second roller comprises at least two engagement covers concentrically disposed over the major surface of the reverse crown roll.

23. An apparatus for coating a moving web, said web comprising a film selected from the group consisting of: bi-axially oriented PET, bi-axially oriented PEN, bi-axially oriented PLA, bi-axially oriented MOF and uni-axially oriented MOF, said apparatus comprising:
a slot die;
a first roller positioned so as to be in contact with the moving web prior to it being coated from the slot die, the first roller and slot die being on opposite side of the moving web; and
a second roller positioned so as to be in contact with the non-coated side of the moving web after it being coated;
wherein the second roller comprises a reverse crown roll comprising:
a roller having an outer surface, a first end and a second end, a midpoint having a midpoint diameter midway between the first end and the second end, and a variable outer diameter;
a first material layer attached to the outer surface and extending in opposing directions from a first distance from the midpoint to the first end and from a second distance from the midpoint to the second end;
a second material layer attached to the first material layer and extending in opposing directions from a third distance from the midpoint to the first end, and from a fourth distance from the midpoint to the second end, wherein the third distance is greater than the first distance, and the fourth distance is greater than the second distance; and
an engagement cover comprising a resilient engagement surface, the engagement cover disposed over the outer surface, the first material layer, and the second material layer, wherein the resilient engagement surface comprises a resilient looped pile, and the resilient looped pile comprises a fibrous material having a loop height not greater than 1.5 mm and a denier not greater than 144.

24. The apparatus for coating a moving web of claim 23, wherein the first distance and the second distance are approximately equal, and the third distance and the fourth distance are approximately equal.

25-31. (canceled)

32. The apparatus for coating a moving web of claim 23, wherein the resilient engagement surface is a knit fabric comprising a base layer having first and second faces and a resilient looped pile protruding from the first face.

33. The apparatus for coating a moving web of claim 32, wherein the base layer comprises a woven base layer, a knitted base layer, a non-woven base layer, or a combination thereof.

34. The apparatus for coating a moving web of claim 23, wherein the engagement cover attaches to the outer surface of the reverse crown roll by compression, adhesion, mechanical attachment, or a combination thereof.

35. The apparatus for coating a moving web of claim 23, wherein the engagement cover comprises a tube shape or a rectangle shape.

36. The apparatus for coating a moving web of claim 32, wherein the resilient looped pile comprises a fibrous material selected from poly(tetrafluoroethylene), aramid, polyester, polypropylene, nylon, or a combination thereof.

37. The apparatus for coating a moving web of claim 32, wherein the resilient looped pile comprises a fibrous polyester material.

38-39. (canceled)

40. The apparatus for coating a moving web of claim 23, wherein the second roller comprises at least two engagement covers concentrically disposed over the outer surface of the reverse crown roll.

41. The apparatus for coating a moving web of claim 1, wherein the slot die, the first roller, and the second roller are each at least 1 meter wide, as measured in the direction perpendicular to the direction of a web to be coated.

42. A method for coating a moving web, comprising:
providing an apparatus according to claim 1:
providing a web material comprising a film selected from the group consisting of: bi-axially oriented PET, bi-axially oriented PEN, bi-axially oriented PLA, bi-axially oriented MOF and uni-axially oriented MOF;
providing a fluid coating material;
conveying the web material in a downweb direction such that it first contacts the first roller of the apparatus; then passes proximate to the slot die; and then contacts the second roller; and
metering the fluid coating material from the slot die onto the web material;
wherein the web material passing proximate to the slot die is kept from contact with the slot die only by the elastohydrodynamic force created by the metering of the fluid coating material from the slot die onto the web material.

43. A method for coating a moving web, comprising:
providing an apparatus according to claim 23;
providing a web material comprising a film selected from the group consisting of: bi-axially oriented PET, bi-axially oriented PEN, bi-axially oriented PLA, bi-axially oriented MOF and uni-axially oriented MOF;
providing a fluid coating material;
conveying the web material in a downweb direction such that it first contacts the first roller of the apparatus; then passes proximate to the slot die; and then contacts the second roller; and
metering the fluid coating material from the slot die onto the web material;
wherein the web material passing proximate to the slot die is kept from contact with the slot die only by the elastohydrodynamic force created by the metering of the fluid coating material from the slot die onto the web material.

44. The apparatus for coating a moving web of claim 23, wherein the slot die, the first roller, and the second roller are each at least 1 meter wide, as measured in the direction perpendicular to the direction of a web to be coated.
